(19) United States
(12) Patent Application Publication
(10) Pub. No.: US 2017/0352052 A1
(43) Pub. Date: Dec. 7, 2017

(54) ADVERTISING RECOMMENDATIONS USING PERFORMANCE METRICS

(71) Applicant: Linkedln Corporation, Mountain View, CA (US)

(72) Inventors: Dominic W. Law, Sunnyvale, CA (US); Venkata S.J.R. Bhamidipati, Fremont, CA (US); Kaiyang Liu, Saratoga, CA (US); Yingfeng Oh, Cupertino, CA (US); Darren Stephen Lee, Mountain View, CA (US)

(21) Appl. No.: 15/172,360

(22) Filed: Jun. 3, 2016

(51) Int. Cl. G06Q 30/02; G06Q 50/00

(52) U.S. Cl. CPC G06Q 30/0243; G06Q 30/0277; G06Q 50/01

(57) ABSTRACT

This disclosure relates to systems and methods for generating an advertising recommendation. In one example, a method includes determining a statistical performance level threshold for a plurality of advertising entities advertising, identifying one of the advertising entities that fails to meet the statistical performance level threshold, determining a variance associated with the one advertising entity as compared with others of the plurality of advertising entities that do satisfy the performance threshold constraint, generating a recommendation to the one advertising entity that addresses the variance, and transmitting the recommendation to the one advertising entity.

### TECHNICAL FIELD

The subject matter disclosed herein generally relates to advertising and, more particularly, to generating advertising recommendations using performance metrics.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating a system for generating advertising recommendations using performance metrics, according to one example embodiment.

FIG. 3 is a block diagram illustrating another system for generating advertising recommendations using performance metrics, according to one example embodiment.

FIG. 4 is a flow chart diagram illustrating a method of generating advertising recommendations using performance metrics, according to another example embodiment.

FIG. 5 is a flow chart diagram illustrating another method of generating advertising recommendations using performance metrics, according to another example embodiment.

FIG. 6 is a flow chart diagram illustrating another method of generating advertising recommendations using performance metrics, according to another example embodiment.

FIG. 7 is a block diagram illustrating components of a machine, according to some example embodiments, able to read instructions from a machine-readable medium (e.g., a machine-readable storage medium) and perform any one or more of the methodologies discussed herein

### DETAILED DESCRIPTION

The description that follows includes systems, methods, techniques, instruction sequences, and computing machine program products that embody the inventive subject matter. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to generating advertising recommendations using performance metrics. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example, a system analyzes performance metrics for a plurality of advertisers and determines one or more advertisers that are performing at a lower level than others. In one example, the advertiser is yielding less profits than others. In another example, the advertiser receives less clicks, or other responses.

In response, the system identifies the advertiser that is performing at a level that fails to meet a statistical performance level threshold and determines a variance for that advertiser. In one example, the variance is an advertising cost, an advertising budget, certain terms in an advertising slogan, image content, advertiser name or other identifying information, or any other property of an advertiser.

One example benefit of such a system is that a member of an online social network service may configure an advertising campaign and receive insights and/or recommendations regarding the performance of the campaign as compared with other like advertising entities without downloading performance metrics and performing an individual analysis. Furthermore, the member may simply accept a recommendation without having to manually modify campaign parameters.

Another benefit addresses fluctuation of seasonal demands. For example, as holidays, seasons, weekday/weekend, or other factors temporarily affect a user's purchases and the effectiveness of advertising, a system as described herein identifies advertising entities that do not perform as well as others during the different time periods and may recommend changes to an advertising campaign to address the cause of the deficiency.

Data for campaign and/or advertising reports for specific advertisers do not address these issues because they cannot address the competitive landscape of many advertisers, fluctuation in advertising demands, and/or predictive capability based, at least in part, on existing delivery performance.

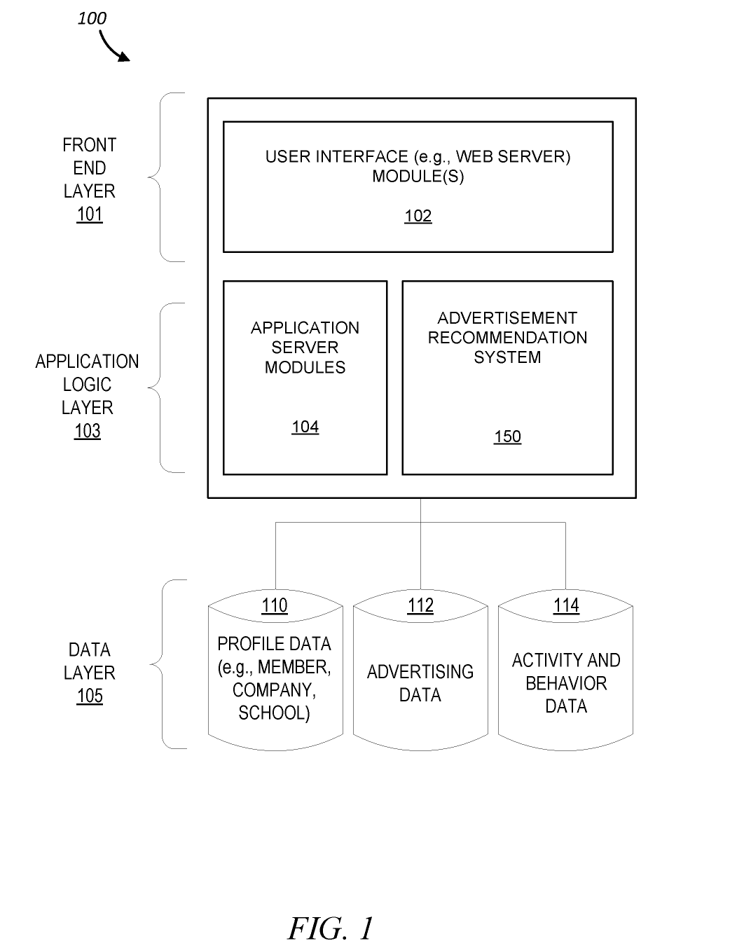

FIG. 1 is a block diagram illustrating various components or functional modules of an online social networking service 100, in an example embodiment. The online social networking service 100 may generate an advertising recommendation using performance metrics. In one example, the online social networking service 100 includes an advertisement recommendation system 150 that performs many of the operations described herein.

A front end layer 101 consists of one or more user interface modules (e.g., a web server) 102, which receive requests from various client computing devices and communicate appropriate responses to the requesting client devices. For example, the user interface module(s) 102 may receive requests in the form of Hypertext Transfer Protocol (HTTP) requests, or other web-based, application programming interface (API) requests. In another example, the front end layer 101 receives requests from an application executing via a member's mobile computing device.

An application logic layer 103 includes various application server modules 104, which, in conjunction with the user interface module(s) 102, may generate various user interfaces (e.g., web pages, applications, etc.) with data retrieved from various data sources in a data layer 105. In one example embodiment, the application logic layer 103 includes the advertisement recommendation system 150 which provides advertising media content to the client computing devices that requests data and tracks interaction with the advertising media content as described herein.

In some examples, individual application server modules 104 may be used to implement the functionality associated with various services and features of the online social networking service 100. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service 100 may be embodied in their own application server modules 104. Alternatively, various applications may be embodied in a single application server module 104.

As illustrated, the data layer 105 includes, but is not necessarily limited to, several databases 110, 112, 114, such as a database 110 for storing profile data, including both member profile data and profile data for various organizations. In certain examples, an advertising database 112 includes campaign and advertising data for members of the online social networking service 100. In other examples, the user interface modules 102 are configured to receive advertising data to be included in the advertising database 112. In one example, the advertising database 112 includes, but is not limited to, advertising media content, images, videos, text, advertising frequency, advertising budgets, an advertising campaign, slogans, trademarks, jingles, audio, or any other advertising media content.

Consistent with some examples, when a person initially registers to become a member of the online social networking service 100, the person may be prompted to provide some personal information, such as his or her name, age (e.g., birthdate), gender, sexual orientation, interests, hobbies, contact information, home town, address, spouse's and/or family members' names, educational background (e.g., schools, majors, matriculation and/or graduation dates, etc.), occupation, employment history, skills, religion, professional organizations, and other properties and/or characteristics of the member. This information is stored, for example, in the database 110. Similarly, when a representative of an organization initially registers the organization with the online social networking service 100, the representative may be prompted to provide certain information about the organization. This information may be stored, for example, in the database 110, or another database (not shown).

The online social networking service 100 may provide a broad range of other applications and services that allow members the opportunity to share and receive information, often customized to the interests of the member. For example, in some examples, the online social networking service 100 may include a message sharing application that allows members to upload and share messages with other members. In some examples, members may be able to self-organize into groups, or interest groups, organized around subject matter or a topic of interest. In some examples, the online social networking service 100 may host various job listings providing details of job openings within various organizations.

As members interact with the various applications, services, and content made available via the online social networking service 100, information concerning content items interacted with, such as by viewing, playing, and the like, may be monitored, and information concerning the interactions may be stored, for example, as indicated in FIG. 1 by the database 114. In one example embodiment, the interactions are in response to receiving a message requesting the interactions.

Although not shown, in some examples, the online social networking service 100 provides an API module via which third-party applications can access various services and data provided by the online social networking service 100. For example, using an API, a third-party application may provide a user interface and logic that enables the member to submit and/or configure a set of rules used by the advertisement recommendation system 150. Such third-party applications may be browser-based applications, or may be operating system specific. In particular, some third-party applications may reside and execute on one or more mobile devices (e.g., phones or tablet computing devices) having a mobile operating system.

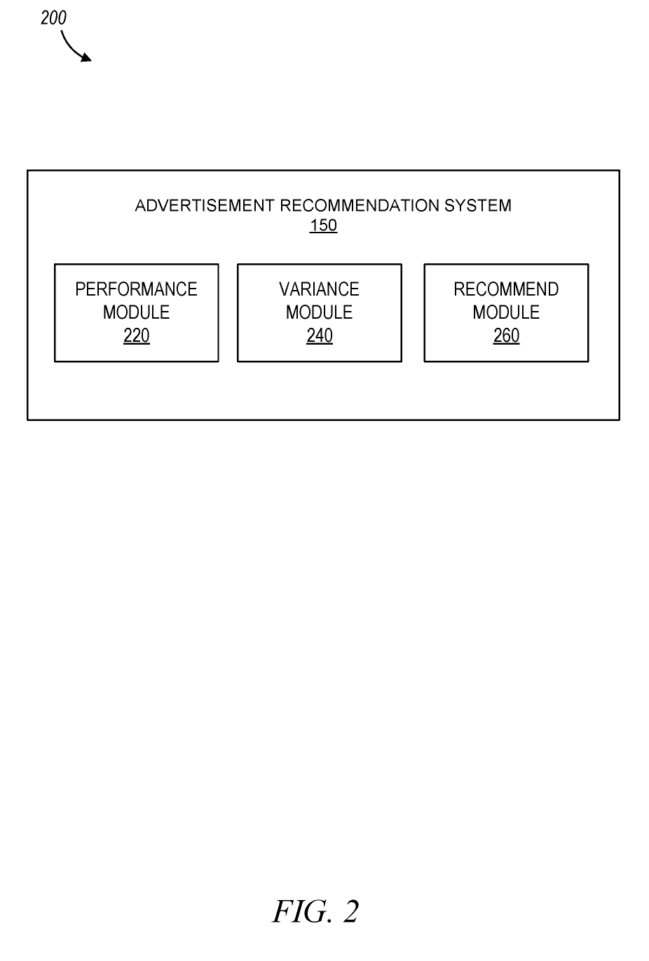

FIG. 2 is a block diagram illustrating a system 200 for generating advertising recommendations using performance metrics, according to one example embodiment. In one example embodiment, the system 200 includes a performance module 220, a variance module 240, and a recommend module 260.

In one example embodiment, the performance module 220 is configured to determine a statistical performance level threshold for a plurality of advertising entities advertising via an online social networking service 100. In one example, the performance metrics are based on results of advertisements disseminated using the online social networking service 100.

In one example embodiment, the performance metrics are not related to campaign objectives. In one example, a campaign objective may be to achieve a threshold number of clicks, however, the system 200 may determine that a click-through-rate for the advertisements are lower than 95% of other advertisers and may determine that the advertiser is not meeting a minimum performance metric.

In one example embodiment, the performance metrics are based on advertisements from similarly configured advertisers. In one example, the advertisers are from a similar industry, such as, but not limited to, automotive, manufacturing, engineering, software development, management, finance, or other industries. In another example, the advertisers are selected based on similar budget sizes. In one example, advertisers with an annual advertising budget of between $50,000 and $100,000. In another example, the advertisers are selected according to a size. For example, advertisers may be selected because of a number of employees, annual profits, or the like. Of course, other factors may be used and this disclosure is not limited in this regard. In other examples, the advertisers are selected according to target audience type, product type, service type, target audience demographics, or other, or the like.

In one example embodiment, the performance module 220 measures, for a plurality of advertisers, metrics that include, but are not limited to the following: average money spent over a recent threshold period of time, total money spent, a number of days left for a campaign, pacing (e.g., remaining budget divided by days left for campaign), daily pacing, audience size, number of creatives, CTR (Click-Through-Rate) benchmark, bid percentile, reach, daily expenses, CTR over a recent period of time, campaign competiveness (e.g., bid winning percentage), campaign modification frequency, creative quality score, or the like.

In one example, the advertising media content is a DirectAd. As described herein, a DirectAd describes a scenario where an advertiser and a publisher of an advertisement from the advertiser do not use a 3^{rd} party to arrange. In this scenario, metrics may be collected by the publisher of the advertisement without communicating with a 3^{rd} party.

In another example embodiment, DirectAds do not generate impressions on a daily basis. In response, the performance module 220 compares campaigns that have impressions over a recent period of time (e.g., hourly, daily, weekly, monthly, etc.). In one example, an advertiser's campaign over the past week is ranked 70% among DirectAds campaigns with a number of impressions over the past week being at least 1000.

In one example embodiment, the performance module 220 identifies an advertising entity that fails to meet a statistical performance level threshold. In one example, the performance identifies a statistical performance level threshold as 0.30% CTR because the 10% worst performing advertising entities have CTR's that are lower than 0.30%. In another example, the performance module 220 receives a statistical performance level threshold from an administrator of the online social networking service 100.

In another example embodiment, the performance module 220 determines a count of percentage of bids lost due to the bid amount being lower than other bid amounts. In one example embodiment, the performance module 220 determines a median CTR and identifies one or more advertising entities with CTR's that are below the median CTR. In other examples, the performance module 220 uses a median engagement rate, a median number of viral impressions (e.g., % of total impressions that are classified as “viral.”), a median engagement bonus, or other, or the like. In another example embodiment, the performance module 220 identifies many advertising entities that fail to meet a statistical performance level threshold. In one example, an impression that is classified as “viral” is an impression that experiences exponential growth in interactions over a recent period of time.

In one example embodiment, the variance module 240 is configured to determine a variance associated with the one advertising entity as compared with others of the plurality of advertising entities that do satisfy the performance threshold constraint. In one example, the advertising entities that meet the statistical performance level threshold have larger budgets and the variance module 240 determines that the variance is a budget amount.

In another example embodiment, the variance module 240 determines that a bid amount for advertisements from the advertising entities that fail to meet the statistical performance level threshold is lower than all the bid amounts for advertising entities that meet the statistical performance level threshold. In this example, the variance module 240 determines that the bid amount is the variance.

In another example embodiment, the advertising entities are used car dealers and variance module 240 determines that the variance is terms included in the advertisements for the used car dealers. In one example, an advertising entity that fails to meet the statistical performance level threshold includes “cheap cars,” as opposed to others of the used car dealers that do not use the term “cheap” to refer to their cars. In this example, the variance is a specific term in a slogan or advertisement.

In another example embodiment, the variance module 240 determines a variance in response to an indicator from an administrator of the online social networking service 100. In one example, the administrator recognizes that a used car salesman by the name of “Slick Rick,” may be less effective than another name for the dealership. In response to the administrator setting an indicator for the advertising entity using a user interface, the variance module 240 determines that the indicator is the variance.

In one example embodiment, the recommend module 260 is configured to generate a recommendation to an advertising entity that fails to meet the statistical performance level threshold. In another example embodiment, the recommendation identifies the variance and includes a remedy for the variance. In one example, the variance is a bid amount that is below a threshold value and the recommendation suggests to increase the bid amount to match the bid amount for other advertising entities that meet the statistical performance level threshold.

In another example embodiment, the recommend module 260 transmits the recommendation to the advertising entity that fails to meet the statistical performance level threshold value. In one example, the recommend module 260 sends an email. In another example, the recommend module 260 sends an SMS text message. In another example embodiment, the recommend module 260 causes the recommendation to be displayed at a computing device being used by an advertising entity representative.

In one example, the advertising entity interfaces with the online social networking service 100 using a web browser being executed on a client device and the recommend module 260 transmits the recommendation via the network connection between the online social networking service 100 and the web browser. In this way, the web browser displays the recommendation. In other embodiments, the web browser displays options to the advertising entity to either accept or reject the recommendation.

In another example embodiment, the recommendation includes the statistical performance level threshold and the variance. In one example, in response to the statistical performance level threshold value being CTR, the recommendation includes the CTR for the advertising entity and the CTR for other advertising entities that do meet the statistical performance level threshold.

In one example embodiment, the variance module 240 determines two or more variances for an advertising entity and the recommend module 260 includes each of the variances. In another example embodiment, the recommend module 260 also includes estimated effects applying changes recommended by the recommendation. In one example embodiment, the recommend module 260 orders the variances based on their associated estimated effects. In this way, the recommendation includes several options for the advertising entity. Of course, the user interface may enable the advertising entity (or a person representing the advertising entity), to reject or apply one or more of the changes recommended by the recommendation. In this way, the recommendations are scored based, at least in part, on an estimated level of effectiveness.

In one example embodiment, the recommendation includes one or more changes to address each of the variances. In one example, the changes may be selected from any of the following: a bid amount, a budget, use of a specific term, phrasing, and a property of an image.

In certain examples, the variance module 240 identifies properties of an advertising image. In one example, the variance is a size of an image. For example, if an image it too large, it may not be successfully transmitted to a user before the user moves to another page and although the image may otherwise be effective, the advertising campaign may not be effect due to the size of the image. In this example, the variance is the size of the image and the recommendation may include a change to decrease the size of the image to be more consistent with other advertising entities that do meet the statistical performance level threshold.

In another example embodiment, the performance module 220 identifies one or more underperforming advertising entities automatically (e.g., without interaction with a user) in response to the performance metrics for the advertising entity falling below the identified statistical performance level threshold.

In one example embodiment, the recommendation includes a recommendation to include additional creatives, increase a target audience, decrease (e.g., more focused or narrow) a target audience, increase a bid amount, increase a budget, or other, or the like.

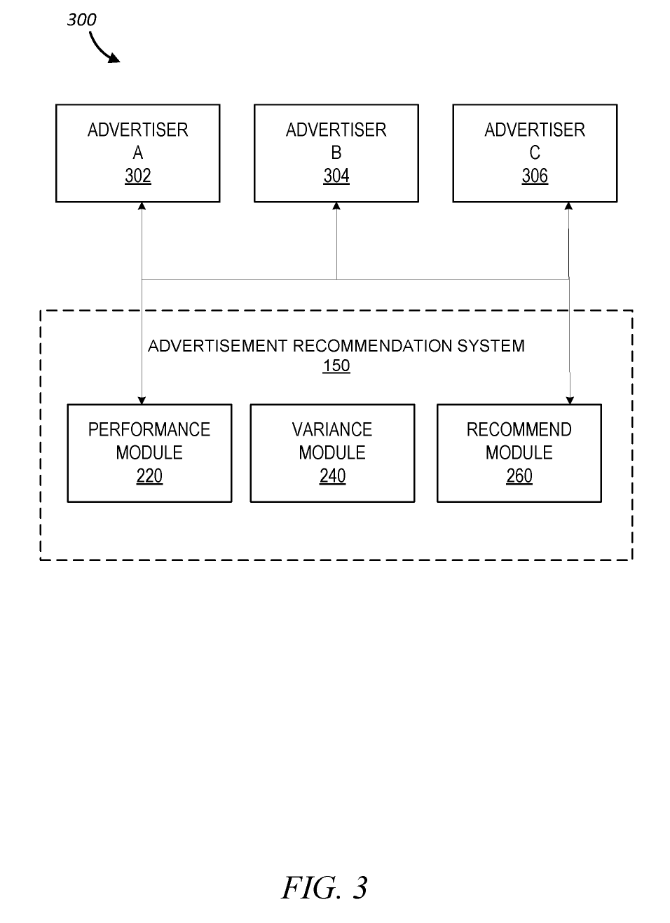

FIG. 3 is a block diagram illustrating another system 300 for generating advertising recommendations using performance metrics. In one example embodiment, the system 300 includes the advertisement recommendation system 150, and a plurality of advertisers 302, 304, and 306.

In one example embodiment, the performance module 220 monitors performance data for the advertisers 302, 304, and 306. In one example, Advertiser A 302 exhibits a CTR at 60%. In one example, the CTR is calculated using the previous 7 days. Of course, other periods may be used and this disclosure is not limited in this regard. In another example, the CTR is calculated from a previous change in an advertising campaign for the advertiser 302.

In one example, a DirectAds campaign for advertiser 302 is ranked at 20% among selected advertising entities at the online social networking service 100. In response, the performance module 220 identifies the advertiser 302 as not meeting a statistical performance level threshold (e.g., 25% CTR). In response, the variance module 240 identifies one or more variances between the advertiser 302 and the other advertisers 304 and 306.

In another example, budget pacing for advertiser 304 is 30% behind advertisers 302 and 306. In one example, the performance module 220 identifies a statistical performance level threshold as 30% because 30% is the lowest pacing amount among the advertisers 302, 304, and 306. In one example, the pacing (P) formula is given by Equation 1:

P=100*(total_budget*days_spent/(total_spent*days_total)−1) Equation 1

In response, the performance module 220 identifies advertiser 302 as not meeting the performance metric because advertiser 302's pacing falls below the statistical performance level threshold of 30%. In another example embodiment, the pacing calculation is limited to weekdays or other period of time that exhibits consistent advertising effort.

In another example embodiment, an advertising bid for advertising entity 304 is 60% of the average winning bid over the past 7 days as compared with advertising entities 304 and 306. In this example, the performance module 220 sets the statistical performance level threshold to be the average winning bid amount, for example, $10. In response, the performance module 220 identifies advertising entity 304 as not meeting the statistical performance level threshold.

In one example embodiment, the variance module 240 determines that if the bid is increased by 20%, the campaign's impressions will increase 100%, and clicks by 80%, based on performance metrics of other advertising entities that are currently meeting the statistical performance level threshold. In another example, the variance module 240 determines that if the bid is increased by 40%, the campaign's impressions will increase 160% and clicks increase by 120%. In another example, the variance module 240 determines that if the bid is increased by 100%, the campaign's impressions will increase 200%, clicks 160%. In another example embodiment, the variance module 240 determines that the variance is a geographical location of viewers of an advertisement and the recommendation includes adjusting the target audience to viewers in more responsive locations.

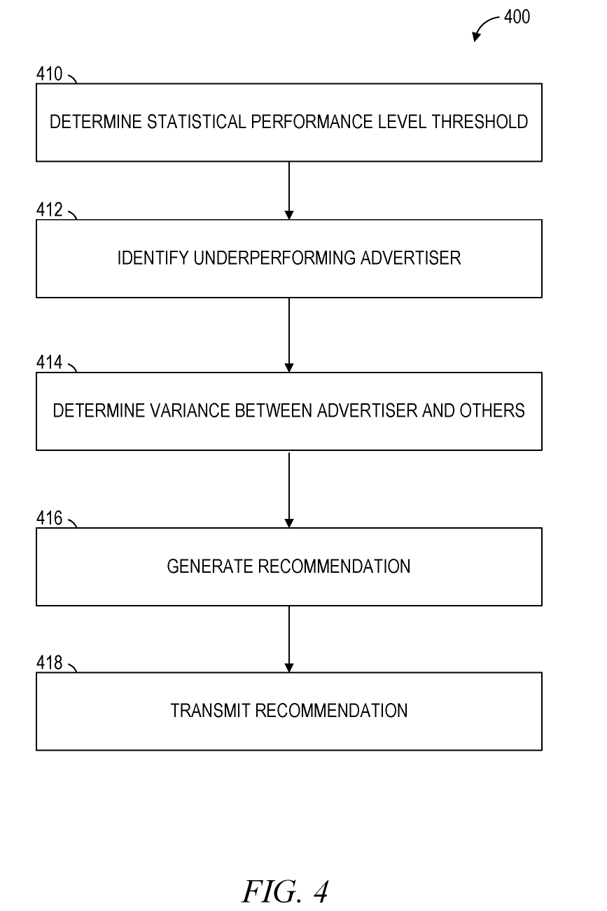

FIG. 4 is a flow chart diagram illustrating a method of generating advertising recommendations using performance metrics, according to another example embodiment. According to one example embodiment, the method 400 is performed by one or more modules of the advertisement recommendation system 150 and is described by a way of reference thereto.

In one example embodiment, the method 400 begins and at operation 410, the performance module 220 determines a statistical performance level threshold for a plurality of advertising entities advertising via an online social networking service 100. In one example, the statistical performance level threshold is based on results of advertisements from the advertising entities and disseminated using the online social networking service 100.

The method 400 continues at operation 412 and the performance module 220 identifies an advertising entity 304 that fails to meet the statistical performance level threshold in any way as described herein. The method 400 continues at operation 414 and the variance module 240 determines a variance associated with the advertising entity that failed to meet the statistical performance level threshold as compared with others of the plurality of advertising entities that do satisfy the statistical performance level threshold.

The method 400 continues and at operation 416 the recommend module 260 generates a recommendation to the one advertising entity that addresses the variance. In one example, the recommendation includes one or more changes that are expected to change the variance.

The method 400 continues and at operation 418 the recommend module 260 transmits the recommendation to the advertising entity that failed to meet the statistical performance level threshold. In another example embodiment, the advertisement recommendation system 150 performs the method 400 on a daily basis or at any other regular interval, such as, but not limited to, weekly, monthly, or other.

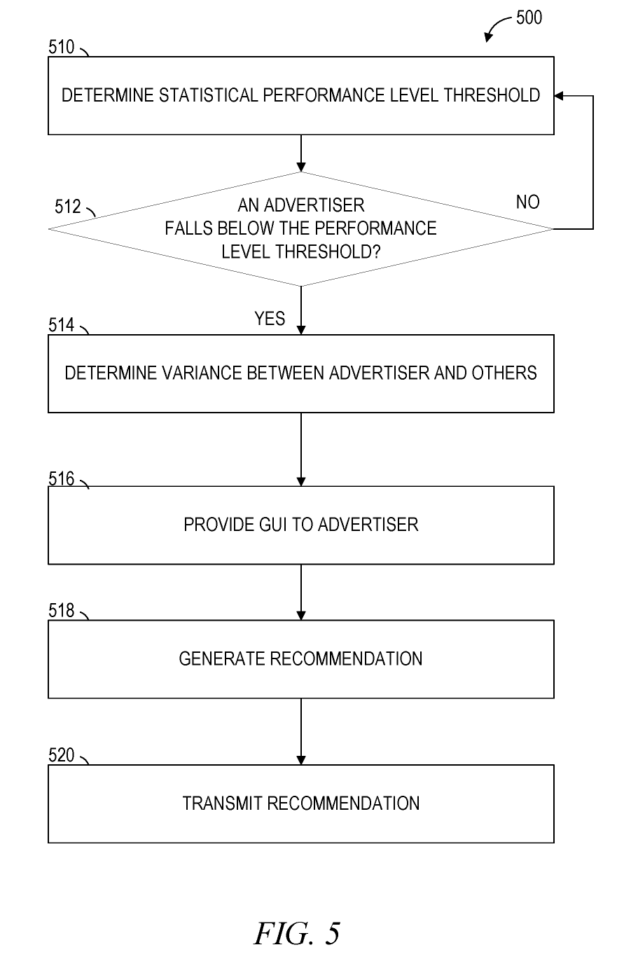

FIG. 5 is a flow chart diagram illustrating another method 500 of generating advertising recommendations using performance metrics, according to another example embodiment. According to one example embodiment, the method 500 is performed by one or more modules of the advertisement recommendation system 150 and is described by a way of reference thereto.

In one example embodiment, the method 500 begins and, at operation 510, the performance module 220 determines a statistical performance level threshold for a plurality of advertising entities advertising via an online social networking service. In one example, the statistical performance level threshold is a median CTR for the plurality of advertising entities.

The method 500 continues at operation 512 and the performance module 220 determines whether an advertising entity's performance has fallen below the statistical performance level threshold. In one example, the performance module 220 determines whether an advertising entity's CTR has fallen below the media CTR. In response to no advertising entity's performance falling below the statistical performance level threshold, the method 500 continues at operation 510. In response to an advertising entity's performance falling below the statistical performance level threshold, the method 500 continues at operation 514.

At operation 514, the variance module 240 determines a variance associated with the advertising entity that failed to meet the statistical performance level threshold as compared with others of the plurality of advertising entities that did satisfy the performance threshold constraint.

The method 500 continues at operation 516 and the variance module 240 provides a user interface that allows the user to view the statistical performance level threshold, view the variance, view the recommendation, apply the recommendation, or change an advertising parameter. Of course, the user interface may be configured to allow the advertising entity (or a person representing the advertising entity) to make other modifications to an advertisement, advertising campaign, or other and this disclosure is not limited in this regard.

The method 500 continues and at operation 518 the recommend module 260 generates a recommendation to the advertising entity that addresses the variance between the advertising entity and other advertising entities that currently meet the statistical performance level threshold. The method 500 continues and at operation 510, the recommend module 260 transmits the recommendation to the advertising entity (or a person that represents the advertising entity) that failed to meet the statistical performance level threshold.

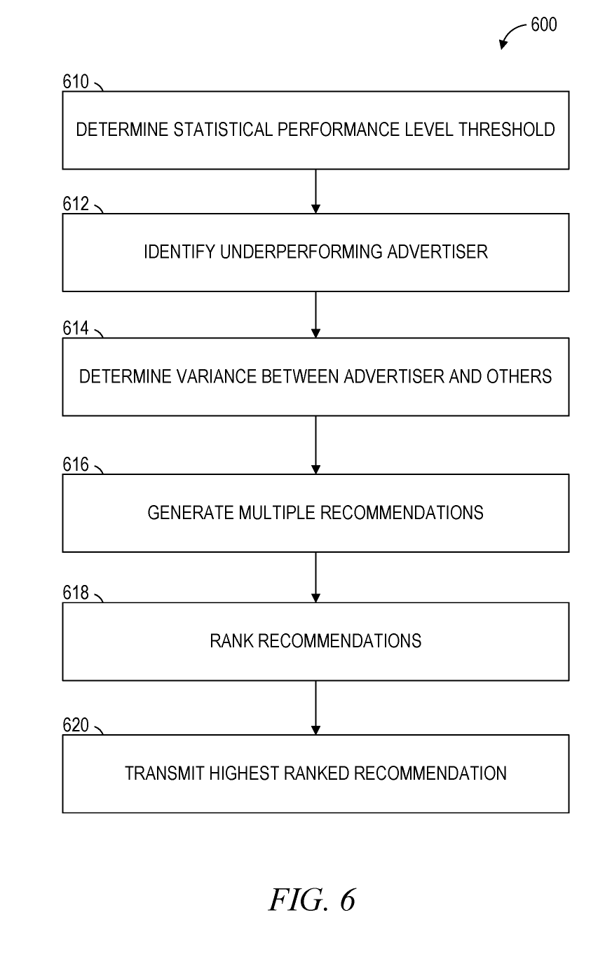

FIG. 6 is a flow chart diagram illustrating another method of generating advertising recommendations using performance metrics, according to another example embodiment. According to one example embodiment, the method 600 is performed by one or more modules of the advertisement recommendation system 150 and is described by way of reference thereto.

In one example embodiment, the method 600 begins and, at operation 610, the performance module 220 determines a statistical performance level threshold for a plurality of advertising entities advertising via an online social networking service 100. In one example, the statistical performance level threshold is a number of clicks per dollar expended.

The method 600 continues at operation 612 and the performance module 220 identifies an advertising entity that fails to meet the statistical performance level threshold in any way as described herein. The method 600 continues at operation 614 and the variance module 240 determines a variance associated with the advertising entity that failed to meet the statistical performance level threshold as compared with others of the plurality of advertising entities that did satisfy the performance threshold constraint.

The method 600 continues at 616 and the recommend module 260 generates many recommendations to an advertising entity that address the variance. In one example, the recommendations include changes to the advertisement or campaign that are expected to change the variance to increase the statistical performance of the advertising entity.

The method 600 continues at operation 618 and the recommend module 260 ranks the recommendations according to an estimated level of effectiveness. In one example, the estimated level of effectiveness is an estimated profit increase based on performing the recommendation. The method 600 continues and, at operation 620, the recommend module 260 transmits the highest ranked recommendation to the advertising entity that failed to meet the statistical performance level threshold. In another example embodiment, the recommend module 260 transmits each of the recommendations to the advertising entity.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-6 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

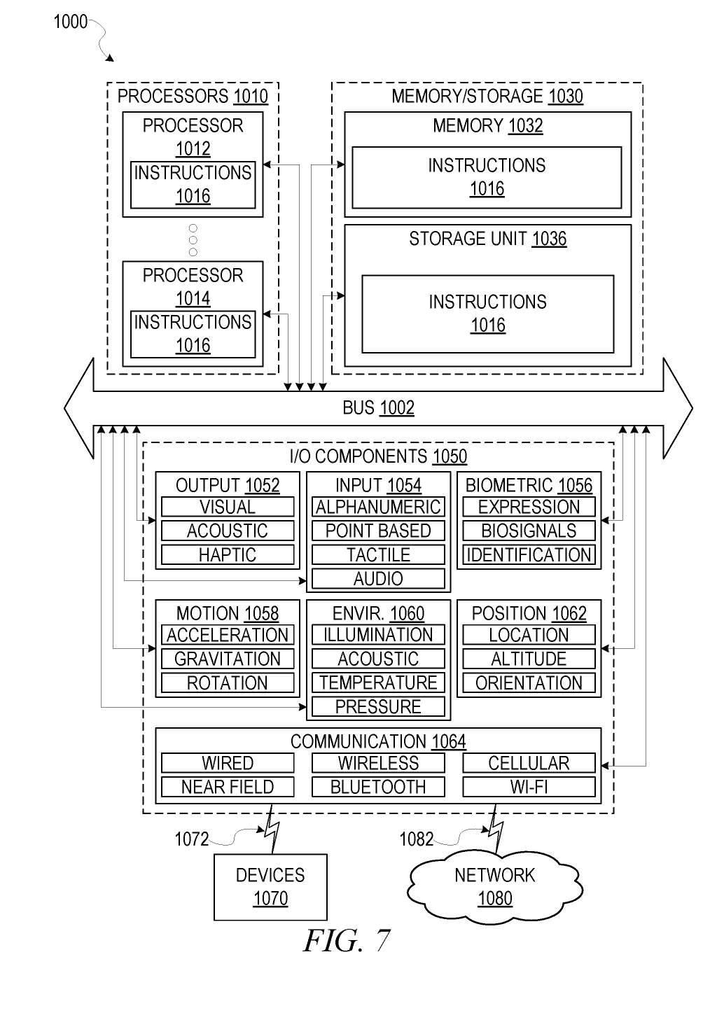

FIG. 7 is a block diagram illustrating components of a machine 1000, according to some example embodiments, able to read instructions from a machine-readable medium (e.g., a machine-readable storage medium) and perform any one or more of the methodologies discussed herein

Specifically, FIG. 7 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions 1016 may cause the machine 1000 to execute the flow diagrams of FIGS. 4-6. Additionally, or alternatively, the instructions 1016 may implement one or more of the components of FIG. 2. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors (sometimes referred to as “cores”) that may execute instructions contemporaneously. Although FIG. 7 shows multiple processors, the machine 1000 may include a single processor with a single core, a single processor with multiple cores (e.g., a multi-core processor), multiple processors with a single core, multiple processors with multiples cores, or any combination thereof

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 9. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a machine-readable medium having instructions stored thereon, which, when executed by a processor, performs operations comprising:
determining a statistical performance level threshold for a plurality of advertising entities advertising via an online social networking service, the performance level threshold based on results of advertisements from the advertising entities and disseminated using the online social networking service;
identifying one of the advertising entities that fails to meet the statistical performance level threshold;
determining a variance associated with the one advertising entity as compared with others of the plurality of advertising entities that do satisfy the performance threshold constraint;
generating a recommendation to the one advertising entity that addresses the variance; and
transmitting the recommendation to the one advertising entity.

2. The system of claim 1, wherein the operations further comprise providing a user interface to a user of the system that allows the user to perform at least one of viewing the statistical performance level threshold, viewing the variance, viewing the recommendation, applying the recommendation, and changing an advertising parameter.

3. The system of claim 1, wherein the plurality of advertising agencies are selected according to one of an industry, a similar budget size, a similar size, and a similar target audience.

4. The system of claim 1, wherein the recommendation includes the statistical performance level threshold and the variance.

5. The system of claim 1, wherein the operations further comprise generating more than one recommendation and scoring the recommendations based on an estimated level of effectiveness.

6. The system of claim 1, wherein the recommendation comprises at least one of a bid amount, a budget, use of a specific term, phrasing, and a property of an image.

7. The system of claim 1, wherein the operations further comprise automatically generating the recommendation in response to an entity's performance falling below the statistical performance level threshold.

8. A method comprising:
determining a statistical performance level threshold for a plurality of advertising entities advertising via an online social networking service, the performance level threshold based on results of advertisements from the advertising entities and disseminated using the online social networking service;
identifying one of the advertising entities that fails to meet the statistical performance level threshold;
determining a variance associated with the one advertising entity as compared with others of the plurality of advertising entities that do satisfy the performance threshold constraint;
generating a recommendation to the one advertising entity that addresses the variance; and
transmitting the recommendation to the one advertising entity.

9. The method of claim 8, further comprising providing a user interface that allows the user to perform at least one of viewing the statistical performance level threshold, viewing the variance, viewing the recommendation, applying the recommendation, and changing an advertising parameter.

10. The method of claim 8, wherein the plurality of advertising agencies are selected according to one of an industry, a similar budget size, a similar size, and a similar target audience.

11. The method of claim 8, wherein the recommendation includes the statistical performance level threshold and the variance.

12. The method of claim 8, further comprising generating more than one recommendation and scoring the recommendations based on an estimated level of effectiveness, the transmitting comprises transmitting the recommendation with the highest estimated level of effectiveness.

13. The method of claim 8, wherein the recommendation comprises at least one of a bid amount, a budget, use of a specific term, phrasing, and a property of an image.

14. The method of claim 8, further comprising automatically generating the recommendation in response to an entity's performance falling below the statistical performance level threshold.

15. A non-transitory machine-readable medium having instructions stored thereon, which, when executed by a processor, cause the processor to perform:
determining a statistical performance level threshold for a plurality of advertising entities advertising via an online social networking service, the performance level threshold based on results of advertisements from the advertising entities and disseminated using the online social networking service;
identifying one of the advertising entities that fails to meet the statistical performance level threshold;
determining a variance associated with the one advertising entity as compared with others of the plurality of advertising entities that do satisfy the performance threshold constraint;
generating a recommendation to the one advertising entity that addresses the variance; and
transmitting the recommendation to the one advertising entity.

16. The non-transitory machine-readable medium of claim 15, wherein the operations further cause the processor to provide a user interface to a user of the system that allows the user to perform at least one of viewing the statistical performance level threshold, viewing the variance, viewing the recommendation, applying the recommendation, and changing an advertising parameter.

17. The non-transitory machine-readable medium of claim 15, wherein the plurality of advertising agencies are selected according to one of an industry, a similar budget size, a similar size, and a similar target audience.

18. The non-transitory machine-readable medium of claim 15, wherein the recommendation includes the statistical performance level threshold and the variance.

19. The non-transitory machine-readable medium of claim 15, wherein the operations further cause the processor to generate more than one recommendation and score the recommendations based on an estimated level of effectiveness.

20. The non-transitory machine-readable medium of claim 15, wherein the operations further cause the processor to automatically generate the recommendation in response to an entity's performance falling below the statistical performance level threshold.
